(19) United States
(12) Patent Application Publication
(10) Pub. No.: US 2003/0212636 A1
(43) Pub. Date: Nov. 13, 2003

(54) Children's computer banking game

(76) Inventor: Paul Resnick, Beverly Hills, CA (US)

Correspondence Address: DYKAS, SHAVER & NIPPER, LLP, P O BOX 877, BOISE, ID, 83701-0877, US

(21) Appl. No.: 10/141,168

(22) Filed: May 7, 2002

(51) Int. Cl. G09B 19/18; G06F 17/60

(52) U.S. Cl. 705/42; 434/107

(57) ABSTRACT

An educational interactive money management method for use in an arrangement comprising at least one computer network connecting at least one display device to at least one information-provider computer. The method having the steps of: displaying a graphic user interface connected to an electronically accessible financial account having at least one game; establishing a system of authorization governing access and transfer of information to and from the graphic user interface and the financial account; and processing information and transactions to and from the graphic user interface as permitted by the system of authorization.

### BACKGROUND OF THE INVENTION

1. Field of the Invention

The present invention generally relates to children's educational software, and more particularly to a method for teaching money management skills to a child by linking a children's computer game to an online banking service.

2. Background Information

It has been estimated that by the average age of twenty-four, more than one-half of all consumers have a bank account, at least one credit card, some form of an insurance policy and an auto loan. Although these consumers have financial obligations, many of them feel ill prepared to manage such responsibility. High rates of consumer debt and bankruptcy demonstrate that some consumers are indeed ill prepared to manage these items. One reason for this may be a lack of information and/or experience with managing financial matters on the part of consumers.

Some instruction regarding the managing of finances may be obtained through classes taught in public school systems, educational games and other traditional means. However, success in these forms of learning may not necessarily correlate with a participant's acquisition of proficiency or comfort with a variety of financial matters. These more traditional methods of learning generally do not engage participants in transactions with the actual money that they are managing. Thus, a later shift from theory to reality may prove difficult.

Many children and young adults have grown up around various forms of computer technology and feel completely comfortable interacting with a computer with regard to many aspects of their lives. One of the benefits of such familiarity is the development and use of educational software. Many types of educational software have been developed to teach children a variety of subjects, including reading, math, spelling, art, music and other subjects. These software programs generally allow a participant to progress through the software until a point where the software program is generally completed. Software and computer based programs also exist which allow a party to access banking and money management services.

There is, however, no method known to the inventor whereby an individual can learn about money management while advancing toward actually managing money through an interactive transitioning game.

Accordingly, it is an object of the invention to provide an educational program interface linked to a banking account whereby a person can be introduced to banking and money management in a friendly and comfortable manner. Another object of the invention is to provide a selectable interface utilizing educational games and technology to teach financial management skills to children. It is a further object of the invention to provide a selectable, transitioning banking interface whereby an account holders interacts with their account through a display interface which adapts and changes as the account holder grows and progresses.

### SUMMARY OF THE INVENTION

These objects are achieved using an educational, interactive money management method performed in an arrangement comprising at least one computer network connecting at least one display device to at least one information-provider computer. The method comprises the steps of: displaying a graphic user interface having a variety of educational games, activities and information; creating a connection between an electronically accessible financial account and the graphic user interface; establishing a system of administrative rules governing access and transfer of information between the graphic user interface and the financial account; sending information and opportunities for interaction to the graphic user interface; responding to the input from the graphic user interface with an appropriate action as permitted by an account administrator; receiving and transferring deposits from a variety of depositors into the electronically accessible account; notifying depositors when a deposit has been received; notifying the account holder and the account administrator when deposits have been placed within the electronically accessible account; receiving information from a variety of sources including electronically accessible bank accounts, financial and news reporting services and other locations; displaying the received information on the customizable graphic user interface according to the selected parameters of the system of administration; and transmitting reports regarding the account to various parties as designated by the account administration.

Still other objects and advantages of the present invention will become readily apparent to those skilled in this art from the following detailed description wherein I have shown and described only the preferred embodiment of the invention, simply by way of illustration of the best mode contemplated by carrying out my invention. As will be realized, the invention is capable of modification in various obvious respects all without departing from the spirit and scope of the invention. Accordingly, the drawings and description of the preferred embodiment are to be regarded as illustrative in nature, and not as restrictive.

### BRIEF DESCRIPTION OF THE DRAWINGS

FIG. 1 is a modified block diagram of the environment in which the invented method is utilized.

FIG. 2 is a flowchart illustrating the account user portion of the preferred embodiment of the invented method.

FIG. 3 is a flowchart illustrating a portion of the embodiment of the method described in FIG. 2.

FIG. 4 is a flowchart illustrating a part of the depositor interaction portion of the method.

### DESCRIPTION OF THE PREFERRED EMBODIMENTS

While the invention is susceptible of various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

The invented method connects an electronically accessible financial transaction account to a customizable graphic user interface on a display device. The invented method is designed to be implemented in a system wherein at least one display device is connected to an Internet server. Preferably, the display device is connected through a wired Internet service, such as a computer or television. However, mobile devices such as cellular telephones, personal digital assistant (PDA), smart-phones, or other devices with appropriate wireless connections, may also be used. A Wireless Application Protocol (WAP) enabled system will support and recognize a display that connects over most wireless networks and most conventional types of applications and operating systems. A WAP enabled system may be used in the present embodiment.

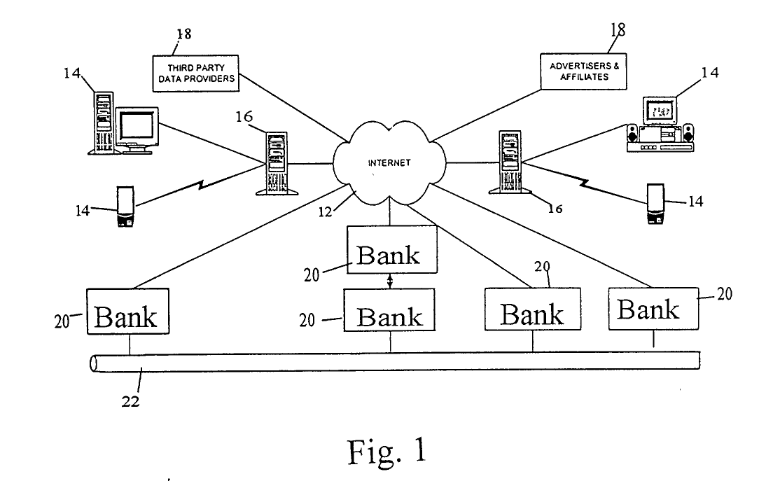

A diagram of the type of environment in which the method can be employed is shown in FIG. 1. This figure shows a variety of Internet accessible devices 14 connecting to the Internet 12. The Internet 12 also allows for interconnection between the display devices 14 and their associated users and a variety of banks and financial institutions 20 interconnected through a financial network 22. The Internet also allows these parties access to a variety of other parties 18 including data providers, advertisers and affiliates, news reporting services, entertainment companies and others. The financial institutions 20 have methods in place for settling balances and transfers, and for transferring funds among themselves. Access to each of these parties is provided by an Internet Service Provider (ISP) 16, which performs a variety of functions and allows the Internet and its various applications to be accessible.

The ISP 16, or Network Application Service Provider provides an N-tiered, fault tolerant infrastructure for the system. This includes a variety of security means, and access features such as directory services, SSL, WAP, Firewall and the like. The ISP may also have the ability to provide any or all of the following services including: web analytics and reporting, system administration, applications hosting, transport and database services as well as have its own billing structure and services.

The method of this invention is embodied in an application software that may be accessed by a variety of means. This application may be accessed over the Internet through a designated website, or it may be loaded on to a transferable storage media, such as a CD, which then can be installed upon a designated display device 14.

Security of information and access to the application are maintained by cookies (small files) which are automatically sent to the display device. Information stored in cookies can then be accessed any time that a user with that display device returns to the site. When this occurs, the application then checks for the cookies to know which accounts are connected with which device. Cookies allow websites to “personalize” their appearance by identifying visitors, storing passwords, tracking preferences, and other possibilities. In addition to the use of cookies in the application, other conventional security and tracking means are also used in the application. For instance, to access their account users are asked to login to the system by providing a specific password. The provided password is then compared to a designated password. If the passwords match, access to the personalized display and the electronic financial account is obtained.

The described method links the interactive service to an electronically accessible money management account. In situations with smaller children, or newer users, a new account will typically be a savings account with limited checking. However, existing accounts such as checking, money market, brokerage and other types of accounts may also be linked to the interactive services and the games contained therein.

The actual creation of the electronically accessible account can be achieved in a variety of ways. The account can be created from a drop down options menu accessible from the graphic user interface displayed on the display device 14. Selecting this option would redirect the user to a specified bank's online application form. The account can also be created by the user accessing the bank's online application form through a separate means or Internet address. An account may also be created by physically going to a banking institution and creating the account.

To connect the interactive service described in the method to the electronic account, the online payment service must know the account holder's name and routing and account number to which funds will be transferred. With this information, a linking connection between the account and the interactive service of the method can be formed.

The access and interaction of the features of the method are monitored and governed by a system of administrative rules set forth by a system administrator. These rules govern the information sent, received and displayed upon the display device, as well as assist in monitoring and regulating access to the account.

The parties involved with and coordinated by this method fall into three basic categories. First are account holders or users, typically children, who hold the accounts. Second are depositors, usually adults, who make deposits into the children's accounts. Third are account administrators, usually parents, guardians or other responsible adults, who set up the account and select the system of rules and parameters, which will govern the flow of information into and out of the accounts through the application.

In a preferred embodiment, the administrative rules provide a variety of default, yet customizable, security levels that are automatically assigned to user groups to allow access to certain information. For example, depositors may only receive deposit and progress reports from the account or the display, account holders may have another set of privileges, while the system administrator may have all of the available access and privileges. The level of security and the amount of permissible access are regulated by the system of administration chosen by the system administrator.

The selection of a system of rules allows an account administrator to regulate the privileges that an account holder may have. For example, young account holders may have read-only privileges to their games and account, while more mature account holders may have advanced abilities such as purchasing power, trading and the like.

The account administrator has complete access to all aspects of the accounts, including withdrawals, transfers, deposits, investments and other events and information. The account administrator also receives account statements and reports, which list information regarding the deposit account as well as credit card payment information, wire funds transfer requests, notifications regarding returned checks, deposits and other information. The administrator also has the ability to open and close accounts, grant access to funds as well as offer incentives and rewards and transfer ownership of the funds in the account.

The account holder may have varying levels of purchasing power depending on the privileges selected by the administrator. The account holder's purchasing power may be designated up to a specified dollar amount or a percentage of the account funds made available by the administrator. This allows the account holder not only to play games on the screen itself, but also to actually engage in shopping, investments and the like with a portion of the deposited funds. As these account holders grow and mature, the abilities granted to them by the system administrator may also increase and adapt. Thus, as the skills are learned by participation in the outlined games, they are also implemented as the actual money in the account is managed.

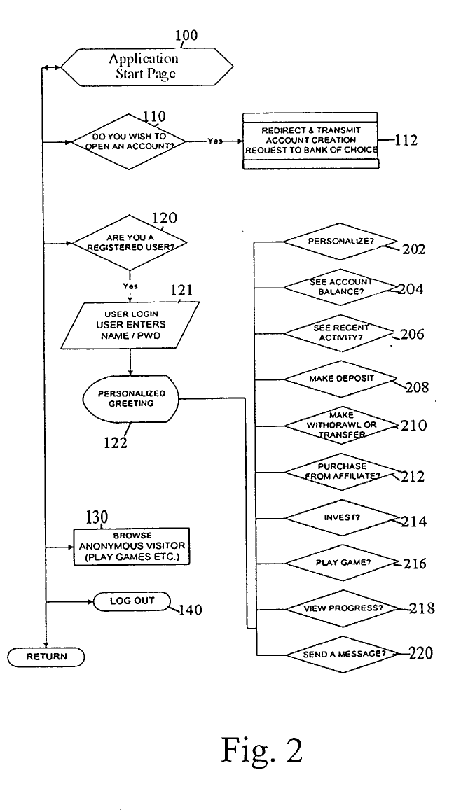

One portion of the method is commenced when a user accesses the application start page. A flowchart of this portion of the method is shown in FIG. 2. This portion of the method commences when the application displays a start page 100 that gives a user a series of options. This application start page 100 may be accessed in a variety of ways, including through the Internet directly to the start page; through the Internet via an affiliated bank's home page, if a connecting link has been established; or through the software loaded onto a display device such as a personal computer. At the start page 100, the user has the option to create an account 110, to login to the system home page and access an existing account 120, to “browse” the site as an anonymous visitor 130, or to exit the application 140.

If the users are not account holders and choose to open an account 110, they are redirected to a participating bank's financial network 112 which then assists him in creating the account with the bank as well as connecting this new banking account to the application.

If the users are a account holders and wish to access their existing account, a login screen is displayed 121. After the account holder has given the appropriate password, the application verifies the password and displays a personalized graphic user interface (GUI) 22 to the account holder.

This GUI 122 is intended to be customizable by the account holders to reflect their desires, attitudes, age and personality. The account holders can frequently customize their GUI 122 similar to the way that they might organize their playroom. They may want to consider having a homepage as a comic book or theme park theme. The option to personalize a GUI 122 is made available at the initial stage when the displayed interface environments are created, as well as at later times such as after login 121. This personalization feature allows for customizing of the GUI 122 as the account holder's interests change. Thus, an account holder could start with one display on their GUI 122, then continue to use this same GUI 122, modifying the display as they choose, while maintaining a constant connection with a financial account linked to this changing GUI 122. This allows the account holders to gain familiarity and competency with money management by presenting the whole arena of money management to them in a manner that feels comfortable to them.

The GUI 122 is designed so as to allow easy, comfortable interaction, and to conform to the personal choices of the account holders. The GUI 122 can be designed to include reports and information from a variety of sources such as financial and news reporting services, children's entertainment services, information regarding hobbies or past times and other locations having information or features desired by the account holder. In a preferred embodiment, the GUI 122 displayed to the account holders and depositors contains a minimum of text and keyboard input. In one possible embodiment, the actions and selections of the account holders are monitored to obtain information regarding their favorite areas and activities. A personalization engine may then react to these monitored specific inputs to modify the display, or to make inferences to push useful information and more challenging activities to the user.

The first GUI 122 display offers a user a variety of options. Account holders may have the ability to personalize their display 202, see their account balance 204, view recent activity on their account 206, make a deposit to the account 208, make a transfer or withdrawal from the account 210, purchase something from an affiliate 212, invest funds from their account 214, play a game 216, view their progress 218, or send a message 220. By selecting the activity the account holder is then able to engage in the activity.

If the account holder selects to send a message 220, a communications system such as an electronic mail (e-mail) system is accessed which allows a message to be sent. If the account holder selects to make a transaction such as a deposit 208, a purchase 212, a transfer or withdrawal 210, or make an investment 214, a system linking the account to a financial transaction system is accessed and the transaction can be completed. This same financial transaction system can also be accessed to allow the account holders to view their account balance. In some applications, the account balance can be automatically updated to be included within the GUI 122. If the user selects to view their progress 218 or see recent activity 206, a report of their results from the games, or a report of account activity will be displayed. If the account holders choose to personalize their GUI 202, they are directed to the personalization engine which enables them to choose the various features that they would like to have in their display.

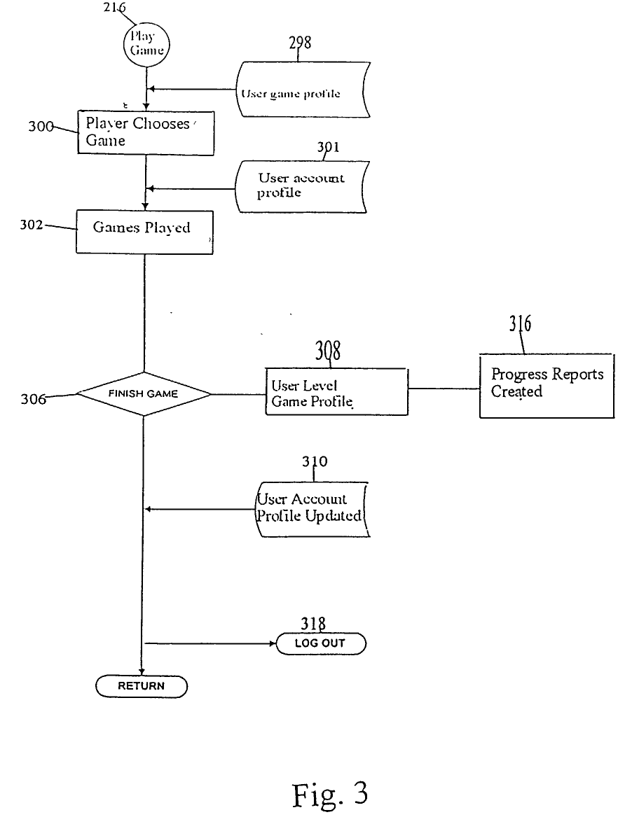

If the party chooses to play a game 216, another portion of the method is accessed. This portion of the invented method is shown in FIG. 3. These games allow for educational and recreational play, and allow a user to gain familiarity with a variety of educational topics, particularly with regard to financial principles and money management. These games can be selectable by the account holder or pre-selected by the account administrator depending upon the rules of the system of administration selected. Upon selecting to play a game 216, the application inputs the user's game profile 298. This profile selects and determines the choices of games that the user may play. The presentations are based upon the system of rules laid out by the system administrator, the progress, age, capabilities and capacity of each user. A large library of games offers multiple gaming challenges and learning activities to the account holders as they mature, or become more adept at the skills involved in the games.

After selecting to play a game, the user's account profile, including information concerning account balances, recent deposits, and funds transfers from a variety of locations, is transmitted to the game 301. The game is then played 302. While the game is being played, the actions and progress of the user in playing the game is monitored and recorded. The results and actions of the games can be linked to the banking account and transmitted according to the system of rules established by the system administrator.

Examples of games include: “Where's the Money” where the user has to search through an environment of forests, castles, rocks, and the like to find the money and determine the quantity of money deposited in their account; and “Who Sent the Money” a game created through a database that allows an individual to select search questions to discover who sent them the money. Audio games, where the user would have to match audio prompts with specified characters or designations on the screen or keyboard, for example, when they hear the word “interest rate,” they must chose the percentage key on the keyboard, or select the % symbol the screen with the mouse, are also envisioned.

Other game ideas include, but are not limited to: “Select the Dots,” “Find the President,” “Mr. Numerator over Mr. Denominator equals Mr. Ratio,” “Coins Regarding The Solar System,” U.S. coin and currency recognition, foreign coin and currency recognition, equivalent fractions, coins over dollar ratios, purchasing power, investment, price/value games, turning decimals to dollars and cents, unit recognition ($, %, etc.), money puzzles, credit versus debt, value of money, lending versus borrowing, how to make change, loans and financing games, deposits versus withdrawals, demand deposits, timed deposits, benefits of each, bull versus bear markets, balance games to learn to balance the user's accounts, fill in the blank numbers where there a set of pull-down numbers is used by a party to fill numbers into spaces to equal an account balance, fill in the blank words where a person is given a value in numbers and must convert them to words, a game where a part owns a company having certain stocks and therefore must account for the gains and losses on their account, games involving how to deal with inflation, how to deal with taxes and their consequences, stock games, puts and calls games, index funds, hedge funds, risk exchange game, markets, sales, revenue, income, earnings, profits, profit margins, cost of goods sold, cash flow, annuities, time value of money, etc. [0039] The games also include mathematical problems such as division, equations, addition, subtraction, multiplication and percentages. These are all types of games beginning with the simplest, “where's the money,” continuing as a person matures into teaching different types of options, funds, tax consequences and the like.

All of the results of the games can be monitored, recorded and even normalized for historical comparison, competition and analysis. If available, national assessments may be utilized to compare the ability of one child at a game to other children at the same game. If enough participants exist, young adults may enter into gaming or investment contests where they can compare their holding results against other contestants.

When an account holder selects to play a game, the results and actions of the games can be directly connected to the actual funds within the person's account. The access to the account and the linkage between the account and the GUI is controlled by the system of administration selected by the account administrator. For example, the account holder may play a game in which achieving a desired score entitles the account holder to receive a designated amount of money. When the account holder plays the game and achieves the designated score, an amount of money will be accepted and deposited into the account. Thus, users can learn the skills involved in the game, as well as learning the necessity of managing their money so as to ensure a desired level of financial growth. The feed back for positive performance encourages the games to be played and the skills to be learned. The games chosen, the levels of difficulty and the rewards for such games are all selectable by the account administrator.

At the end of playing the game 306, the user game profile 308 and the user account profiles 310 are updated. If the user has earned the outlined reward or has progressed to a new level, these options are presented 312. In addition, a series of reports can be formulated by recording the activities of the user in playing the games. The results of these reports can then be compiled and accessed by the administrator, the account holder, or the donor depending upon the system of rules selected by the account administrator 316. Additionally, the reports from these games can be used to formulate a series of rewards and recognition for the account holder as well as to form a basis for adjusting the level of play and the options available to the user.

When the users have finished playing, they may log out and leave the system 318.

The learning experience by children in games involving and managing deposit activities from their relatives and friends is self-reinforcing. The positive feedback and award of incentives motivates children to learn and to excel at the areas outlined in the games.

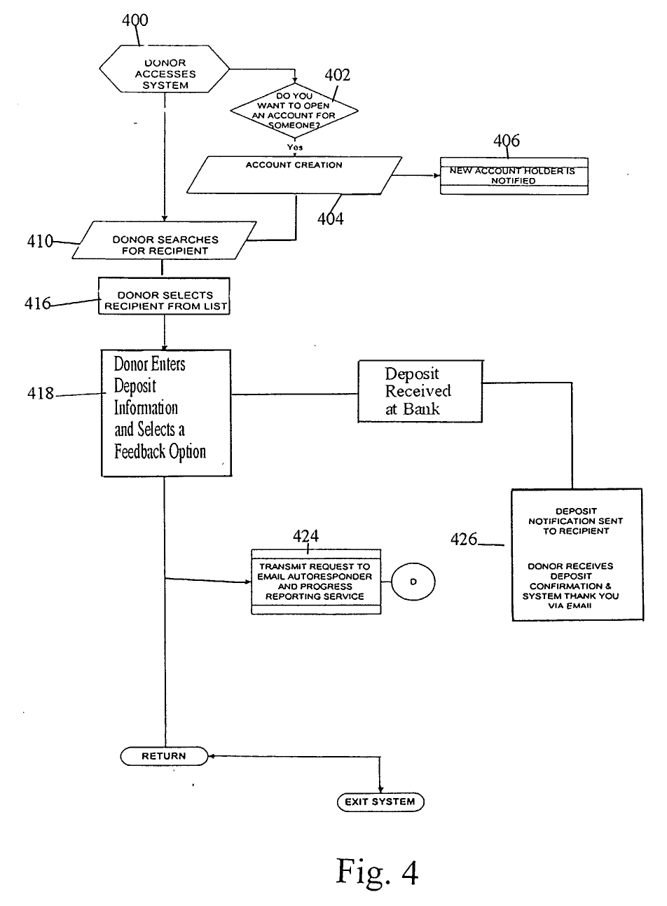

A second, but related, portion of the method involves the obtaining of deposits and the deposition of funds. A flowchart of this part of the method is shown in FIG. 4. Deposits can be made to an account by any person at any time after an account is established.

A deposit is made by a depositor accessing a designated location and directing a deposit to an account holder's account. The depositor needs only to know the name of the recipient in order to make the transaction. Deposit payments can be made through a credit card, debit card, automatic check handling (ACH), electronic check, digital wallet, e-cash, smart card, or other electronic funds transfer (EFT) means.

When depositors present to make a deposit, they access the system 400 and are would, they would like to create an account for someone 402. If they respond that they would, they are directed to an area where they create an account 404 and the account holder is notified 406. Once the account is created, the account holder's name is listed on a list of possible recipients. These recipients can be listed by name or by a unique identifier which designates their account. If the account has already been created, the depositor can go directly to a list of possible recipients 410.

After selecting the individual to receive the deposit 416, the depositor enters the deposit information, and the selected feedback that the donor would like to receive 418. Donors can select to receive automatic verification that the deposit was received or they can select to receive a later verification based upon the acknowledgment of the deposit into the account. The deposit request is then transmitted to a service provider and a bank processor 420, which authorize the transaction. If the transaction is authorized, the deposit is taken from the depositor and placed into the account held at an acquiring bank 422. The balances between the acquiring bank and the balance recorded and displayed on the GUI may be synchronized to reflect the same amount, and reflect the acceptance of the deposit. Simultaneously, notification of the deposit may be sent to the recipient and confirmation of the deposit to the depositor along with a thank you from the system via e-mail 424. In other embodiments, the thank you may alternatively be sent by the recipient to the depositor, or may be done in addition to the automatic notification sent by the application.

The depositor is also given the opportunity to send a message along with their deposit information in step 418. In some applications, the depositor may also receive and view progress reports depending upon the system of rules outlined by the account administrator.

After a deposit is made, the account holder/recipient is automatically notified and directed to view his/her account 426. The deposits in the account are linked to a series of games and rewards which teach users, especially children, important things about money. All of the games are played through the GUI and, depending upon the rules/criteria selected by the account administrator, may or may not impact other applications such as the electronically accessible money management account.

The access to any information regarding the account, the account holder, or the information input into the application from the GUI is monitored and governed by the system of rules selected by the account administrator. Thus, depositors may opt to receive progress reports on the children, if so permitted by a system administrator.

The following scenario illustrates a portion of this method in action:

Mikey, a five-year old kindergartner, loves to get e-mail from his favorite aunts and uncles on the computer. It happens to be Mikey's first day back to school. His Uncle Sam (depositor) has just made a credit card deposit to Mike's account via the online form through a website. The funds from Sam's account go to Mikey's account where they earn interest immediately. Mikey (recipient) and Mikey's father (administrator) both receive an e-mail from the notification system, alerting them that they should visit the interactive banking system to determine what gift or donation was made to the account. Mikey logs on, and is presented with a graphical user interface, which he has personalized and selected to be just the way he wants it. In this instance, Mikey is greeted by a familiar character that he has selected. If Mikey so desires and if the administrative protocol allows, Mikey may change the features of the presentation on the graphic user interface to meet his own particular tastes. In this instance, Mikey's father (administrator) has granted him game selection privileges. Mikey then chooses a game. Mikey's father could also have imposed a random game selection on Mikey, in which case Mikey would not have a choice in what he would do to find the money, but would have to play the randomly selected game.

Mikey selects “Where's the Money,” which is a maze game that opens doors when fractions, which are shown as pie slices, are matched to the corresponding coins or dollar values. The characters in the display and the game give Mikey educational clues along the way until he arrives at the money. Once the game is finished and the money is found, Mike may get an additional reward or tokens from the game sponsors, or could win tokens depending on the account administrator's rules. The basis for the awards could be based on many things, for example, the degree of difficulty, the deposit amount, the solution speed, or other criteria.

After receiving the deposit into the account, Mikey could then type a “thank you” note and accept deposit confirmation to his uncle on his choice of stationary, or he could elect the system to automatically send his uncle a thank you confirmation that his deposit was accepted.

Mikey then goes to his pile of money, which is basically an account statement, where another character explains how it has grown. If his father has granted him access to a portion of the funds, he can see what his purchasing power is and, if also allowed, he may be able to purchase the item he wants through an online electronic transaction mechanism connected to his account.

While there is shown and descried the present preferred embodiment of the invention, it is to be distinctly understood that this invention is not limited thereto but may be variously embodied to practice within the scope of the following claims. From the foregoing description, it will be apparent that various it is shown in this preferred embodiment of the invention, it is to be distinctly understood that this invention is not limited thereto, but may be variously embodied to practice within the following claims.

I claim:

1. A method for use in an arrangement comprising at least one information system network, said network connecting at least one personal display device to at least one information-provider computer said method comprising the steps of:
displaying a graphic user interface having at least one educational game and linked to a financial transaction account on said personal display device;
relaying information including transaction requests from said graphic user interface to said account according to a system of rules designated by an account administrator; and
relaying account information from said account to said graphic user interface;
whereby transaction requests are received from said graphic user interface and transmitted to said financial transaction account according to the system of rules designated by an account administrator and account information is relayed from said account to said graphic user interface according to said system of rules.

2. The method of claim 2, wherein said financial transaction account is a banking account able to receive deposits from a variety of sources and to disperse payments and withdrawals upon direction from an account holder.

3. The method of claim 1, further comprising the step of: establishing a system of account administration rules wherein said rules govern the flow of information and transactions into and out of said graphic user interface.

4. The method of claim 1, wherein said graphic user interface is customizable according to the desires of a user to include information, presentations and formats selected by said user.

5. The method of claim 1, further comprising the steps of: updating account balances as transactions and requests are completed.

6. The method of claim 1, further comprising the steps of monitoring the movements and progress of said user in playing said games; and assessing the ability and progression of said user's movements and progress.

7. The method of claim 6 further comprising the steps of preparing reports regarding said account and said monitoring.

8. The method of claim 7 further comprising the step of transmitting said reports to said account administrator and to depositors.

9. The method of claim 1, further comprising the step of notifying a depositor when a deposit has been received in said financial transaction account.

10. The method of claim 9, further comprising the step of notifying said account holder and said account administrator, when deposits have been placed within said account.

11. A method for teaching financial management to children in an arrangement comprising at least one computer network connecting at least one personal display device to at least one information-provider computer and at least one financial institution server said method comprising the steps of:
displaying a customizable graphic user interface having at least one game and linked to a financial account; and
processing a variety of inputs from said graphic user interface, including conducting at least one financial transaction from direction received from said game;
wherein inputs created from said game are connected to said financial account and a system of administration allows said inputs to perform financial transactions.

12. The method of claim 11 wherein said game is an educational computer game.

13. The method of claim 11 further comprising regulating the processing of transactions based upon a system of administrative rules, said system of administrative rules outlining the restrictions on the processing of transactions.

14. The method of claim 111 further comprising the step of accepting deposits into said account from at least one depositor.

15. The method of claim 11 wherein said game is a children's educational game.

16. The method of claim 15 wherein said display device is a personal computer.

17. The method of claim 15 wherein said display device is a personal digital assistant.

18. The method of claim 14 wherein said display device is a cellular telephone.

19. The method of claim 14 further comprising notifying a user, and an account administrator when a deposit has been received.

20. In an arrangement comprising at least one computer network, said network connecting at least one personal computer to at least one information-provider computer and at least one financial institution server, an interactive educational banking method comprising the steps of:
creating an account with a financial institution;
linking said account to an application software;
establishing a system of administrative rules governing the activities and access to said account, said system of administrative rules governed by an account administrator;
displaying on a personal computer an opening display wherein a party is asked to submit a password;
receiving a login name and password entry from said personal computer;
matching said name/password pair with a designated account;
displaying on said personal computer a graphic user interface, said user interface customizable to reflect the desires, attitudes, age and personality of a user, said graphic user interface comprising a variety of desired educational games, activities, and presentation formats;
receiving information from said graphic user interface;
sending information to said financial institution server;
connecting said graphic user interface with an electronically accessible banking account within an electronically accessible banking system located upon said financial institution server, said account able to receive deposits from a variety of sources and disperse payments and withdrawals according to said system of administrative rules;
regulating a flow of information between said graphic user interface and said account according to said system of rules and regulations;
receiving information from said financial institution server into said application;
transmitting information from said application to said graphical user interface;
receiving deposits from a variety of depositors into said account;
notifying said depositors when said deposit has been received;
notifying said account holder and said account administrator when deposits have been placed within said account according to said system of administrative rules;
receiving requests from said account holder for information transmittal, funds withdrawals, purchases, and transactions from said account;
processing said requests according to said system of administrative rules;
updating account balances as transactions and requests are completed; and
transmitting reports regarding said account, and said games to said account administrator and to a depositor.
